(19) United States
(12) Patent Application Publication
(10) Pub. No.: US 2010/0291422 A1
(43) Pub. Date: Nov. 18, 2010

(54) CAP ASSEMBLY FOR USE IN LITHIUM ION BATTERIES

(75) Inventors: Ping-hua Deng, Dongguan City (CN); Kai Wu, Dongguan City (CN); Wei Chen, Dongguan City (CN)

Correspondence Address: QUINN LAW GROUP, PLLC, 39555 ORCHARD HILL PLACE, SUITE # 520, NOVI, MI, 48375, US

(73) Assignees: Dongguan Amperex Technology Limited, Dongguan City (CN); Dongguan Amperex Electronics Technology Limited, Dongguan City (CN)

(21) Appl. No.: 12/777,290

(22) Filed: May 11, 2010

(30) Foreign Application Priority Data
May 15, 2009 (CN) 200920056632.4

(51) Int. Cl. H01M 2/12

(52) U.S. Cl. 429/82

(57) ABSTRACT

Provided is a cap assembly for use in cylindrical lithium ion batteries. The cap assembly includes an insulating gasket defining a through hole therein, a rupture plate positioned in the through hole, a vent plate soldered on and electrically connected to the rupture plate, a current interrupt device positioned on the rupture plate, and an end cap assembled on the current interrupt device. The current interrupt device can cut off the current path when the battery discharges at a high discharge rate, so as to improve the safety performance of the lithium ion battery.

### CROSS-REFERENCE TO RELATED APPLICATION

The present patent application claims the benefit of Chinese Patent Application No. 200920056632.4, filed May 15, 2009, the disclosure of which is hereby incorporated herein by reference in its entirety.

### FIELD OF THE INVENTION

The present patent application generally relates to lithium ion batteries, and more particularly, relates to a cap assembly for use in lithium ion batteries.

### BACKGROUND OF THE INVENTION

Recently, lithium ion batteries, especially, cylindrical lithium ion batteries, are widely used in various kinds of portable electronic devices, such as video cameras, laptop personal computers, portable DVDs and personal digital assistants, due to high energy density, high working voltage and long life span.

At present, much more attentions have been paid to the safety performance of lithium ion batteries because of the use of high-energy chemical materials and energy concentration. Conventionally, to improve the safety performance of a lithium ion battery, a positive temperature coefficient (PTC) thermistor is provided in the lithium ion battery. When there is a high current in the lithium ion battery because of internal short circuit or external short circuit, the PTC thermistor can remarkably reduce the occurrence of safety accident.

However, for the batteries for use in electric tools which need to discharge at high discharge rate, such as electric vehicle batteries, the PTC thermistor cannot be used any more. Consequently, at present, there is no effective protecting device to improve the safety performance in the cap assembly for use in lithium ion batteries, which need to discharge at high discharge rate. Safety accident may occur in the discharge process of these kinds of batteries.

What is needed, therefore, is to provide a cap assembly with desirable safety performance for use in lithium ion batteries.

### SUMMARY OF THE INVENTION

One object of the present invention is to provide a cap assembly which has desirable safety performance for use in lithium ion batteries.

In accordance with one embodiment of the present invention, a cap assembly includes: an insulating gasket defining a through hole therein, a rupture plate positioned in the through hole, a vent plate soldered on and electrically connected with the rupture plate, a current interrupt device disposed on the rupture plate, and an end cap assembled on the current interrupt device.

According to the embodiment of the present invention, the current interrupt device can fuse and cut off the current path when the lithium ion battery discharges at a high discharge rate, so as to improve the safety performance of the lithium ion battery.

Preferably, the current interrupt device includes an annular insulating plate and a U-shaped metal plate.

Preferably, the metal plate includes a melting portion abutting against the sidewall of the insulating plate and two conductive plates correspondingly resisting on upper and lower surfaces of the insulating plate.

Preferably, the current interrupt device comprises an annular insulating plate and a metal plate enclosing the insulating plate, the metal plate includes two conductive plates and a melting portion connecting the two conductive plates.

Preferably, inner edge of the insulating plate defines an inserting slot, and the melting portion connecting the two conductive plates on upper and lower surfaces of the insulating plate extends through the inserting slot.

Preferably, the insulating plate is formed with an annular stopper at one side thereof, the conductive plate is set around the stopper, so as to securely position the metal plate around the insulating plate.

Preferably, inner diameter of the annular insulating plate is smaller than inner diameter of the conductive plate, outer diameter of the annular insulating plate is larger than outer diameter of the conductive plate, and the two conductive plates are connected to each other only via the melting portion.

Preferably, the metal plate is made from tin or zinc.

Preferably, the fusing current of the current interrupt device is between 50 A to 500 A.

Preferably, the cap assembly further includes an insulating grommet enclosing the vent plate, the insulating grommet is spaced from the inner sidewall of the insulating gasket.

Preferably, the insulating grommet is formed with an mounting slot for safely receiving the vent plate.

Other advantages and novel features will be drawn from the following detailed description of preferred embodiments with the attached drawings. The accompanying drawings, which are incorporated in and constitute a part of this specification, illustrate embodiments of the present invention and, together with a general description of the invention given above, and the detailed description of the embodiments given below, serve to explain the principles of the invention:

### BRIEF DESCRIPTION OF THE DRAWINGS

FIG. 1 depicts a cross-sectional view of a cap assembly for use in lithium ion batteries according to a first embodiment of the present invention;

FIG. 2 depicts a top view of a current interrupt device of the cap assembly for use in lithium ion batteries as shown in FIG. 1;

FIG. 3 depicts a cross-sectional view of the current interrupt device along a line A-A in FIG. 2;

FIG. 4 depicts an enlarged view of a circled portion B in FIG. 3;

FIG. 5 depicts a cross-sectional view of the cap assembly for use in lithium ion batteries as shown in FIG. 1 when assembled on a cylindrical lithium ion battery;

FIG. 6 depicts a top view of a current interrupt device for use in lithium ion batteries according to a second embodiment of the present invention; and

FIG. 7 depicts an enlarged cross-sectional view of the current interrupt device along a line C-C as shown in FIG. 6.

### DETAILED DESCRIPTION OF THE INVENTION

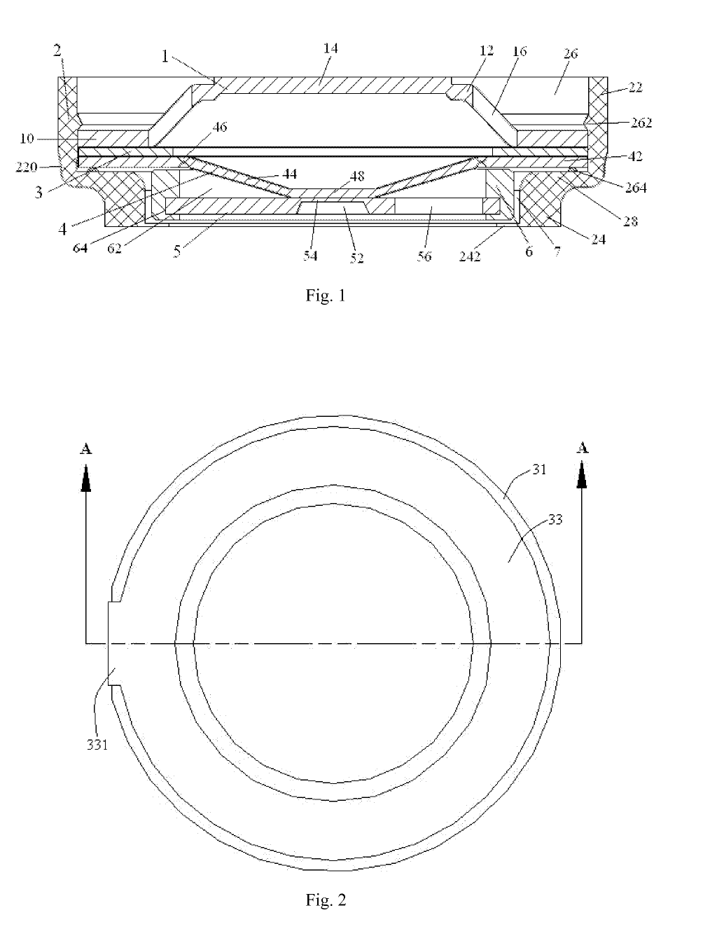

Referring to FIG. 1, the cap assembly for use in lithium ion batteries according to a first embodiment of the present invention includes an end cap 1, an insulating gasket 2, a current interrupt device (hereinafter referred as CID) 3, a rupture plate 4, a vent plate and an insulating grommet 6.

The end cap 1 is formed in a cap shape and includes an annular base portion 10, an oblique portion 12 extending upwardly and obliquely from inner edge of the base portion 10, and a planar top portion 14 located at the top end of the oblique portion 12. The oblique portion 12 defines a number of air exhaust hole 16.

The insulating gasket 2 is a hollow cylinder defining a stepped through hole 26 therein. The insulating gasket 2 includes a clamping end 22 with a larger diameter at an upper end thereof and a retaining end 24 with a smaller diameter at a lower end thereof. Outer surface of the sidewall of the insulating gasket 2 adjacent the retaining end 24 depresses inwardly to form a depressed portion 220. The diameter of the through hole 26 at the clamping end 22 is corresponding to the outer diameter of the end cap 1. Sidewall around the through hole 26 adjacent the clamping end 22 is formed with an annular protrusion 262 extending inwardly. A horizontal step 28 interconnecting the clamping end 22 and the retaining end 24 is formed with an annular sealing projection 264 extending upwardly. The retaining end 24 is formed with an annular flange 242 extending inwardly at the bottom end thereof.

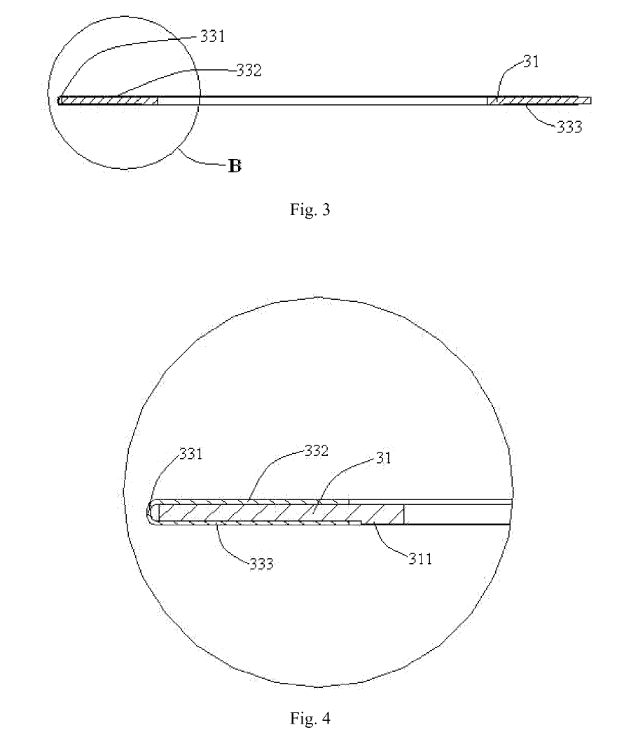

Referring to FIG. 2 to FIG. 4, the CID 3 includes an annular insulating plate 31 and an integrally formed U-shaped metal plate 33. The metal plate 33 is made from metal having lower melting point, such as tin or zinc. The metal plate 33 includes two annular conductive plates 332, 333 and a melting portion 331 connecting the two annular conductive plates 332, 333. The melting portion 331 is located against one sidewall of the insulating plate 33. The two annular conductive plates 332, 333 are correspondingly positioned on upper and lower surfaces of the insulating plate 31. The insulating plate 31 is formed with a protruding annular stopper 311. The conductive plate 333 is set around the annular stopper 311, so as to prevent the metal plate 33 from moving relative to the insulating plate 31. The inner diameter of the insulating plate 31 is smaller than the inner diameter of the conductive plates 332, 333. The outer diameter of the insulating plate 31 is larger than the outer diameter of the conductive plates 332, 333. Therefore, the two conductive plates 332, 333 are electrically connected with each other only via the melting portion 331, while the rest of the two conductive plates 332, 333 are separated from each other by the insulating plate 31.

Further referring to FIG. 1, the rupture plate 4 has a shape similar to that of the end cap 1. The rupture plate 4 includes an outer annular portion 42, a connecting portion 44 extending obliquely and downwardly from the inner edge of the annular portion 42, and a circular recessed portion 48 at a lower end of the connecting portion 44. A groove 46 is defined at the boundary of the connecting portion 44 and the annular portion 42. The rupture plate 4 can be ruptured along the groove 46 when air pressure in the lithium ion battery exceeds a predetermined value.

The vent plate 5 is formed in a disk shape. Central part of the lower surface of the vent plate 5 defines an upwardly recessed channel 52, where a soldering point 54 can be disposed to electrically connect the vent plate 5 with the rapture plate 4. The vent plate 5 is provided with at least one air hole 56.

The insulating grommet 6 is a hollow cylinder having an outer diameter smaller than the diameter of the through hole 26 at the retaining end 24 of the insulating gasket 2. The insulating grommet 6 defines a through-hole 62 at a center thereof. The inner sidewall of the insulating grommet 6 enclosing the through-hole 62 defines an annular mounting slot 64 for receiving the vent plate 5.

In assembly, the vent plate 5 is set in the mounting slot 64 defined in the insulating grommet 6. The insulating grommet 6 having the vent plate 5 received therein is assembled to the rupture plate 4 via the soldering point 54 between the recessed portion 48 of the rupture plate 4 and the vent plate 5. The insulating grommet 6 assembled with the vent plate 5 therein is positioned in the chamber enclosed by the rupture plate 4 and the insulating gasket 2, while other area except the soldering point 54 being electrically insulated from each other. The current in the cap assembly sequentially flows from the vent plate 5 to the external circuit through the soldering point 54, the rupture plate 4, the conductive plate 332, the melting portion 331, the conductive plate 333 and the end cap 1.

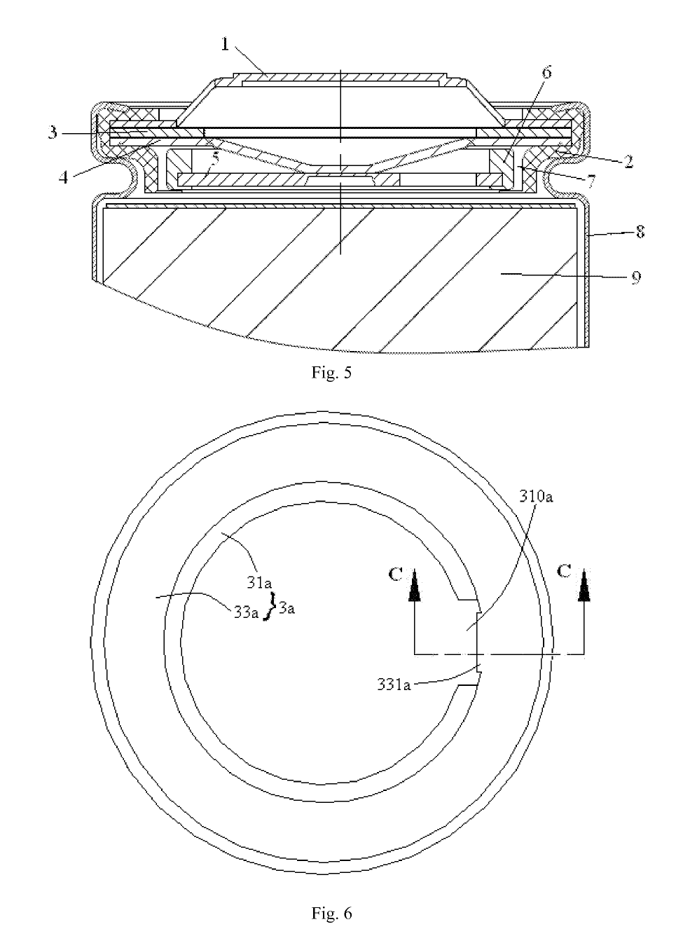

Referring to FIG. 5, in clamping process, the clamping end 22 of the insulating gasket 2 deforms downwardly to the end cap 1 and resist against the annular base portion 10 of the end cap 1 securely under the actuation of the can housing 8. The rupture plate 4 is tightly pressed on the horizontal step 28 of the insulating gasket 2. The annular sealing projection 264 resists tightly on the bottom surface of the outer annular portion 42, so as to seal the inner side of the lithium ion battery from the surroundings.

In the clamping process, the deformation of the insulating gasket 2 possibly actuate the rupture plate 4 to move. If the insulating grommet 6 is fixed, the movement of the rupture plate 4 may breaks the soldering point 54 connecting the vent plate 5 and the rupture plate 4. However, in the embodiment of the present invention as illustrated, the insulating grommet 6 is spaced from the inner sidewall of the insulating gasket 2. In other words, a chamber 7 is defined between the insulating gasket 2 and the insulating grommet 6, so that the insulating grommet 6 and the vent plate 5 can move together with the rupture plate 4. Consequently, disconnection of the vent plate 5 from the rupture plate 4 due to the break of the soldering point 54 is avoided.

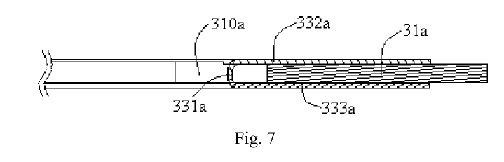

Referring particularly to FIG. 6 and FIG. 7, a CID of a cap assembly for use in lithium ion batteries according to a second embodiment of the present invention includes a metal plate 33a and an annular insulating plate 31a. The metal plate 33a includes a melting portion 331a and two annular conductive plates 332a, 333a coupled together by the melting portion 331a. Different from the first embodiment of the present invention, the insulating plate 33a according to the second embodiment of the present invention defines an inserting slot 310a at the inner edge of the insulating plate 31a. The melting portion 331a for connecting the conductive plates 332a, 333a can extend through the inserting slot 310a. In manufacturing process, the melting portion 331a can be integrally formed with the conductive plate 332a or 333a, and thereafter be soldered to the other one of the conductive plate 333a or 332a after extending through the inserting slot 310a.

When the lithium ion battery functions appropriately, the CID 3, 3a generates little heat. If the lithium ion battery generate high current in charge or discharge process due to internal short circuit or external short circuit, the melting portion 331, 331a of the CID 3,3a in the cap assembly will melt and cut off the current path, to protect the lithium ion battery. According to actual requirement, the fusing current of the CID 3,3a can be selected from 50 A to 500 A.

If the air in the lithium ion battery expands due to high temperature therein, the expanded air will enter the space between the vent plate 5 and the rupture plate 4 via the air hole 56 defined in the vent plate 5. When the air pressure reaches a predetermined value, the rupture plate 4 will disconnect from the vent plate 5 at the soldering point 54 under the actuation of the air pressure to cut off the current path of the lithium ion battery. If the air pressure further increases, the rupture plate 4 will rupture along the groove 46. The air can vent into the surrounding through the air exhaust hole 16 defined in the end cap 1 and, therefore, prevents the lithium ion battery from burning or exploding. In this case, although the vent plate 5 is disconnected from the rupture plate 4, the vent plate 5 will not break away from the rupture plate 4 and fall into the battery cell 9 due to the arrangement of the annular flange 242 of the insulating gasket 2.

It should be noticed that, the cap assembly according to the embodiments of the present invention can be used in power lithium ion batteries, especially lithium ion batteries in battery stack in series or in parallel, for example, the batteries in the electric tools or the electric vehicles.

While the present invention has been illustrated by the above description of the preferred embodiments thereof, while the preferred embodiments have been described in considerable detail, it is not intended to restrict or in any way limit the scope of the appended claims to such details. Additional advantages and modifications within the spirit and scope of the present invention will readily appear to those ordinary skilled in the art. Consequently, the present invention is not limited to the specific details and the illustrative examples as shown and described.

What is claimed is:

1. A cap assembly, comprising:
an insulating gasket defining a through hole therein;
a rupture plate positioned in the through hole;
a vent plate soldered on and electrically connected to the rupture plate;
a current interrupt device positioned on the rupture plate; and
an end cap assembled on the current interrupt device.

2. The cap assembly of claim 1, wherein the current interrupt device comprises an annular insulating plate and a U-shaped metal plate.

3. The cap assembly of claim 2, wherein the metal plate comprises a melting portion abutting against a sidewall of the insulating plate and two conductive plates resisting on corresponding upper and lower surfaces of the insulating plate.

4. The cap assembly of claim 1, wherein the current interrupt device comprises an insulating plate and a metal plate enclosing the insulating plate, the metal plate comprises two conductive plates and a melting portion connecting the two conductive plates.

5. The cap assembly of claim 4, wherein inner edge of the insulating plate defines an inserting slot, the melting portion for connecting the two conductive plates on upper and lower surfaces of the insulating plate extends through the inserting slot.

6. The cap assembly of claim 4, wherein the insulating plate is formed with an annular stopper at one side thereof, the conductive plate is set around the stopper to position the metal plate on the insulating plate.

7. The cap assembly of claim 4, wherein inner diameter of the annular insulating plate is smaller than inner diameter of the conductive plate, while outer diameter of the annular insulating plate is larger than outer diameter of the conductive plate, such that the two conductive plates are connected with each other only via the melting portion.

8. The cap assembly of claim 4, wherein the metal plate is made from tin or zinc.

9. The cap assembly of claim 1, wherein the fusing current of the current interrupt device is between 50 A to 500 A.

10. The cap assembly of claim 1, further comprises an insulating grommet enclosing the vent plate, the insulating grommet is spaced from inner sidewall of the insulating gasket.

11. The cap assembly of claim 10, wherein the insulating grommet defines a mounting slot for safely receiving the vent plate.
